(19) United States
(12) Patent Application Publication
(10) Pub. No.: US 2018/0063730 A1
(43) Pub. Date: Mar. 1, 2018

(54) REMOTE AND LIVE RF NETWORK MEASUREMENT AND OPTIMIZATION

(71) Applicant: Multiple Access Technologies, Inc., Plano, TX (US)

(72) Inventors: YOUNG MIN LEE, ARLINGTON, TX (US); ASIF HASAN, PLANO, TX (US)

(73) Assignee: Multiple Access Technologies, Inc., Plano, TX (US)

(21) Appl. No.: 15/798,644

(22) Filed: Oct. 31, 2017

Related U.S. Application Data
(63) Continuation-in-part of application No. 14/091,350, filed on Nov. 27, 2013.
(60) Provisional application No. 61/761,925, filed on Feb. 7, 2013.

(51) Int. Cl. H04W 24/02; H04L 12/26; H04L 12/24

(52) U.S. Cl. CPC H04W 24/02; H04L 67/34; H04L 41/0672; H04L 43/065

(57) ABSTRACT

An enabling platform is provided where an installed agent (e.g., device-side software) may be installed on a mobile device to decode chipset level information readable on the mobile device. Such readable chipset level information can then be transmitted and/or accessed in real-time via a central server for dynamic, real-time, geo-location for mobile device and network performance enhancement. An important feature of the embodiments of the present invention include the ability to decode and transmit chipset level information from a mobile device in real time so that remote field service data gathering, and local headquarter service assessment and issue resolution, may occur more on a contemporaneous basis, permitting faster issue assessment and resolution, which benefits the telecommunications providers and their customers.

### RELATED APPLICATION

This application claims priority to as a Continuation-in-Part to the non-provisional application Ser. No. 14/091,350 filed Nov. 27, 2013; which claims priority to provisional patent application U.S. Ser. No. 61/761,925 filed on Feb. 7, 2013, the entire contents of which are herein incorporated by reference.

### BACKGROUND

The embodiments herein relate generally to a platform for expediting the diagnosis and resolution of telecommunication services issues with real-time communication between remote field engineers and local diagnostic engineers using the transmission of chipset level data in real time.

Conventional RF (radio frequency wireless communication) measurement and optimization process lacks remote, real time feedback mechanism where the issues can be identified and fixed in real time remotely. Further, these conventional approaches may require clunky equipment, highly trained or experienced personnel leading to high labor cost, and long turn-around time before any optimization options may be identified. Currently, with conventional approaches, RF network data collected in the field has to be physically delivered or uploaded to a remote computer for analysis by an engineer in the office. There is no option for remote live viewing of RF network data as it is measured and collected by the engineer out in the field. Current solutions are expensive, burdensome, lack mobility, and involve multiple pieces of hardware, which requires additional time and resources to set up. Improvements to the measurement, evaluation and optimization of the performance of RF systems are desirable. The conventional approach requires longer turnaround time since the office engineer has to wait for the RF network data to be uploaded or physically delivered to the office. With multiple pieces of hardware involved, solutions currently available have more chances of inaccurate readings, malfunctions, etc.

### SUMMARY

Embodiments and applications of the present invention comprise an enabling platform where an installed agent (e.g., device-side software) on a mobile device is configured to decode chipset level information readable on the mobile device. Such readable chipset level information can then be transmitted and/or accessed in real-time via a central server for dynamic, real-time, geo-location for mobile device and network performance enhancement. An important feature of the embodiments of the present invention include the ability to decode and transmit chipset level information from a mobile device in real time so that remote field service data gathering, and local headquarter service assessment and issue resolution, may occur more on a contemporaneous basis, permitting faster issue assessment and resolution, which benefits the telecommunications providers and their customers.

The present embodiment is illustrated by the new methods contained with the current application to first establishing a method for utilizing a communication engine as a chip level interface to the modem and I/O ports of the device to intercept the complete, unfiltered, and unaltered raw hex coding data streams from these core components of the device; establishing a bi-directional data path between the remote server and the connected device which enables complete autonomous control of the device from the remote server and which grants the operator at the remote location access to the device to directly initiate commands and function requests in manual, or automated fashion, to the chip set of the device; and, which subjects the complete chip set data stream to be captured, compressed and transmitted in byte blocks to the remote server enabling the remote operator, either human or machine, to process the raw data stream in real time to perform every function capable on the device, in addition to any other function or test which the remote server can be programmed to perform without altering, disabling or modifying the device. The present embodiment essentially “exports and streams” the continuous heartbeat of the device core chip processors to the remote server for processing and evaluation and “imports” the competence of the remote operator to manipulate the device in real time

Embodiments of the present invention comprise a platform provided to facilitate the real-time transmission of surface level and chipset level data collected by a remote computerized device (e.g., a mobile smart phone) to a local computerized device (e.g., a desktop computer), where the remote computerized device comprises a downloadable application corresponding to the platform, and the local computerized device comprises a downloadable application or installable software also corresponding to the platform, whereby the platform is configured to manage the real-time transmission of the collected data in streaming fashion either periodically pursuant to an established frequency of transmission or upon the request of the local computerized device. In one embodiment, the platform comprises a remote computerized device configured to collect and transmit—in real-time streaming fashion—surface level and chipset level data reflective of telemetry associated with an ambient RF telecommunications service. The local computer can receive the real-time streaming data collected by the remote device when requested or periodically based upon a pre-established frequency. Embodiments of the present system may also comprise a main or central server configured to store the platform software so that functionality of the platform is performed manually and/or automatically, where the main server is configured to be in wired or wireless electronic communication with the local device and the remote device to permit and facilitate transfer there between.

Applications of the present invention may also comprise methods of facilitating the real-time transmission of surface level and chipset level data collected by a remote computerized device to a local computerized device. In one embodiment, the method may comprise providing a platform configured to manage the real-time transmission of the collected data in streaming fashion either periodically pursuant to an established frequency of transmission or upon the request of the local computerized device. In some embodiments, the method comprises installing a device-side agent on a mobile device, where the device-side agent is configured to permit wireless data transmission to a central server, and collecting telecommunication service telemetry remotely through the exposure of the mobile device with the device-side agent to the telecommunication service telemetry. The methods may also comprise decoding and transmitting in real-time surface level and chipset level data reflective of telemetry associated with the telecommunications service, and receiving via the central server the real-time surface level and chipset level data collected by the remote mobile device, either when requested by a user of the central server, or periodically based upon a pre-established frequency. By providing such a methodology, applications of the present invention comprise assessing the data transmitted in real-time via the local device to the central server to permit telecommunication service assessment, quality, and/or issue resolution, thereby more quickly improving and/or restoring any non-functioning or poorly functioning aspects of the telecommunications service, including assessing the absence of service in specific geographic locations.

The significant advantage of not only being able to establish bi-directional connection with a device; but, through the implementation of the present embodiment, will demonstrate the enablement of 1000's of simultaneous bi-directional device connections as described; which with this new capability alone radically transforms the way in which network performance, customer satisfaction and network planning and optimization can be performed. Considering current industry prior art, inherent limitations of being resident on a single device, utilizing the store, record and forward method of event record reporting, the concept of aggregating live data streams from 1000's of devices operating in direct proximity to one another or situated at specifically spaced intervals across the entire North American Continent introduces functionality which current industry practices could never consider feasible.

### BRIEF DESCRIPTION OF THE FIGURES

The detailed description of some embodiments of the invention will be made below with reference to the accompanying figures, wherein like numerals represent corresponding parts of the figures.

FIG. 1 shows a schematic view of one embodiment of the present invention.

FIG. 2 shows an additional schematic view of one embodiment of the present invention.

### DETAILED DESCRIPTION OF CERTAIN EMBODIMENTS

The RF system monitoring, analysis and optimization solution presented by embodiments and methods of the present invention enable real time feedback mechanisms with remote live monitoring and remote control. The measured and collected RF data does not have to be uploaded and viewed at a later time by the engineer in the office. RF data may be streamed from a smart phone or other portable telecommunications device (i.e., mobile device) through the inventive software described herein and can be viewed live remotely from computers with Internet connection or within a private or public network anywhere in the world while a field engineer is walking, driving or otherwise moving through an area of interest to measure and collect the RF network data.

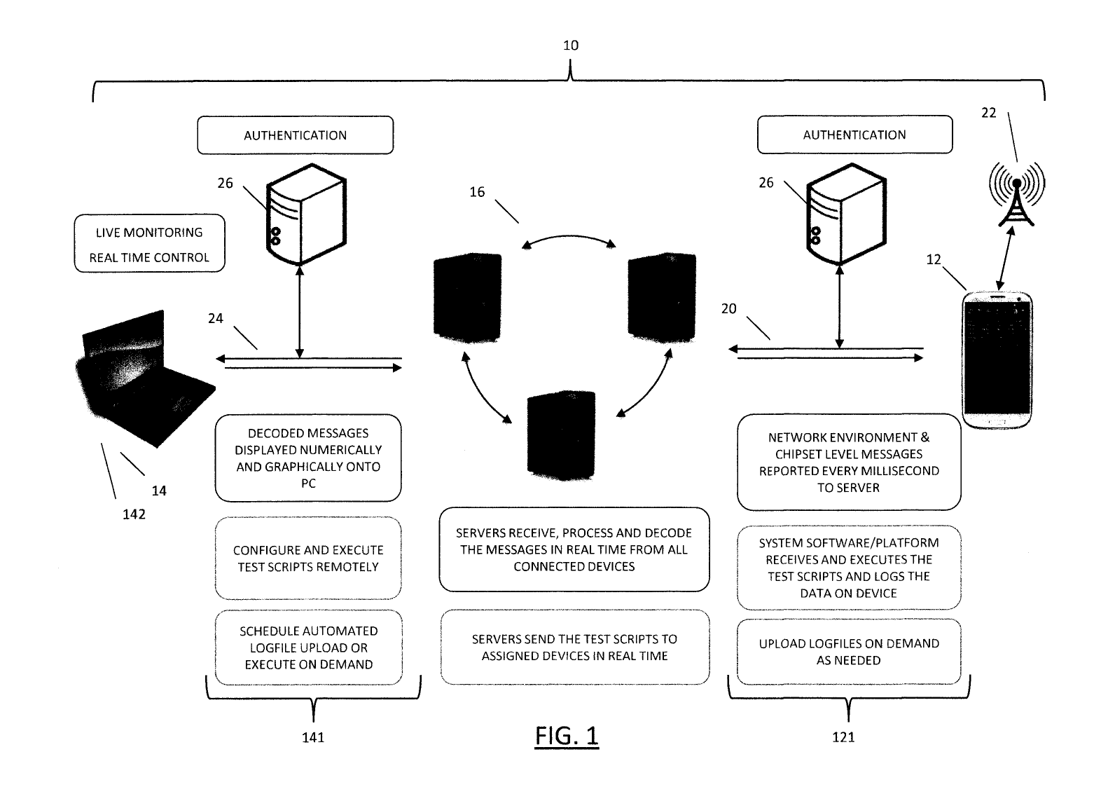

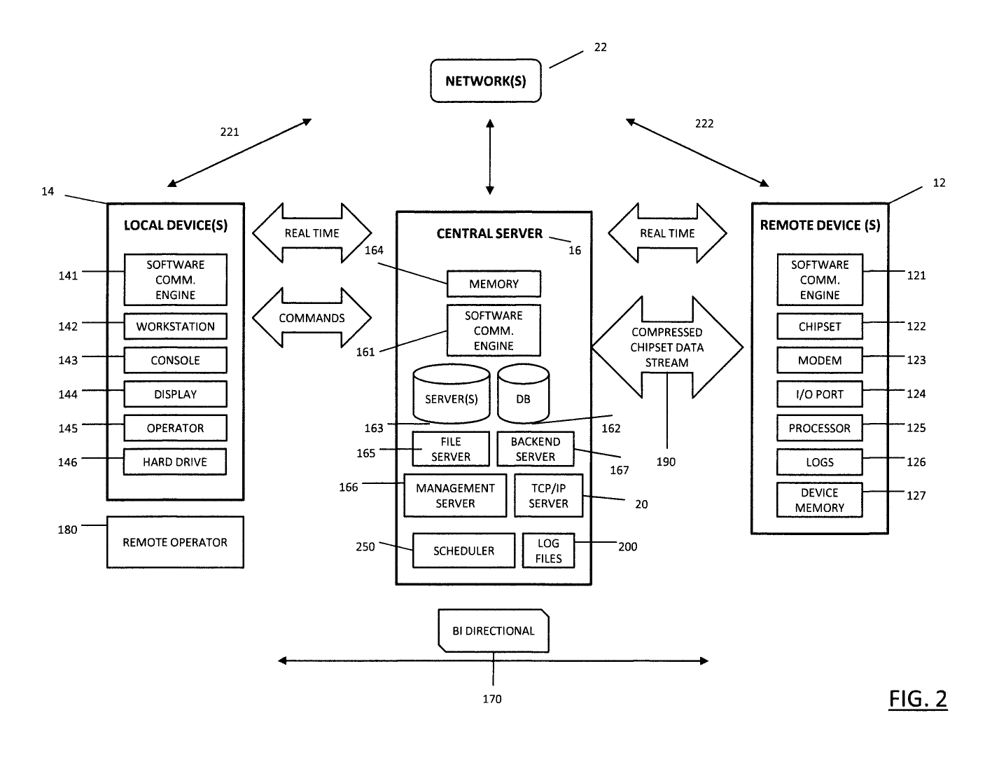

Referring to FIG. 1, in one embodiment 10 for example, device-side software 121 (e.g., a downloadable application) may be installed on a mobile telecommunications device 12. Computer-side software 141, FIG. 2 may be installed on a system engineer workstation 14. Server-side software 141 may be installed on a web server 16 with all three software functionality configured to permit all three devices to communicate with each other. In one embodiment, the device-side software 121 may communicate with the computer-side software 141 using server-side software 161, FIG. 2. The web server 163 comprises memory 164, FIG. 2 sufficient to store and manage data collected and transmitted from the mobile device to the web server. The connection may be established through TCP/IP server 20, where the mobile device comprises a valid data/internet connection via 2G, 3G, 4G networks 22, FIG. 2, for example. A file server 165, FIG. 2 may be employed that functions as a log file (collected data) management server 166, FIG. 2. The servers together may comprise essentially the back-end operations of embodiments of the present invention. In certain embodiments, the central server 16, FIG. 1 comprises part of a back-end server 167, FIG. 2 architecture that is configured to enable synchronization with one or more remote mobile devices 12 in real time, taking advantage of the cloud economics and architecture to connect with any mobile device running the device-side software 121, also called installed agent or communication engine. The back-end server 167 architecture may facilitate instantaneous visualization and display of real-time key metrics of engineering performance accessed from the remote mobile device(s) 12, such as but not limited to, Ec/lo, RSCP, BLER, and/or PSC for 2G, 3G, or 4G devices that have the device side software 121 installed. Therefore, as illustrated, the present embodiment described above is a bi-directional, live, interactive streaming session 170, FIG. 2 is established between the device side 12 and server side 16 components to facilitate real-time actions between the remote operator 180, FIG. 2, human or machine, and the connected device 12.

Now considering the present embodiment, the remote operator 180, either human or machine, having bi-directional, real-time access 170 to both chip set steaming data 190, FIG. 2 and remote control of the device 12, can undertake actions in real time. Here, the remote operator 180 has real-time, live access to 100% of the data 190 available from the chip set 122, FIG. 2 regarding the network 22, the chip set itself 122, and the functions of the device 12 which the remote operator 180 can control. Accordingly, under the present embodiment, the remote operator 180 not only can collect data 170 and interact with the device 12, chip set 122 and network 22 under satisfactory operating conditions when no events or incidents are reported; but, this same solution is available when everything else seems to be going wrong.

In some embodiments, multiple server functions are each performed by a plurality of servers 16, 20, 163, 165, 166, 167 working together, as shown by example in FIG. 1 and FIG. 2. In other embodiments, such server functionality is performed by a single central server 16. In either case, the mobile device 12 (and thereby the remote field engineer) is in communication with the web server 16. Meanwhile, the local system engineer (i.e., an engineer tasked with assessing data and/or resolving technical issues detected by the real-time transmission of surface level and chipset level data 190) and his/her computerized device 14 is also in communication with the web server 16 via a public or private network or via the Internet 24, FIG. 1. The user interface may be through the processing and display of real-time and stored data 190 on the hard drive 146, FIG. 2 of the user's computer, and/or through a web-based application supported by and/or associated with the web server 16. Where desired, and in many cases preferably, embodiments of the present invention comprise an authentication utility feature 26, FIG. 1 whereby communications between the mobile device 12 and the web server 16, as well as the communications between the local computer 14 and the web server 16, are processed via the authentication 26 utility to ensure secure communications.

The device-side software 121 on the mobile telecommunications device 12 may be configured to measure and record RF network data 190 that may be stored on the device 12. Such data 190 may include not only surface level data, but chipset data 190 as well. Both the surface and chipset level data 190 can be viewed in real time during collection stage using the computer-side software 141 through live-streaming of data 190 from the device-side software 121 on the mobile device 12. The data 190 may be received by the server 16, translated and then displayed in numerical, graphical, and mapped formats on the computer-side software 141 for the user to identify and address RF issues. The above process can be carried out on multiple mobile devices 12, and/or on one or more local computerized devices 14, simultaneously. Log files (measurement data) 126, FIG. 2 stored on the mobile devices 12 can be transferred in real-time or uploaded via schedule. Log files 200, FIG. 2 can be replayed, or used to generate reports for further analysis. Additionally, the present embodiment does not rely on the device memory 127, FIG. 2 and operating function to store and forward large data sets 190 to the web server 16. The present embodiment streams compressed real-time chip set data 190 at very low data rates. This payload is extremely light so as not to overburden the device 12 or the network 22 while transferring the data 190. Accordingly, the impact on the performance of the device 12 is minimized. This also means that even if the device 12 is only transmitting intermittently, a partially received data fragment of raw compressed hex code data stream 190 will yield more information about exactly what is happening and what is causing the degraded performance.

Such a solution allows operators to bench mark system performance as a baseline when everything is going great; and, when a degradation of performance is detected, have real-time access to the current conditions to map alongside the baseline established earlier, by 1000's of other unrelated devices 12. Additionally, if the target device 12 is unreachable, the present embodiment 10 can establish connections with other devices 12, even in large quantities, to determine the nature and extent of the problem at hand. Accordingly, the possibilities for how to utilize the present embodiment 10 are endless and bounded only by the willingness of the operator to stream, store and observe live data 190 available from a few select devices 12 or from 1000's of simultaneously connected devices 12.

In embodiments of the present invention, it is preferably that the computer side software 141 loaded onto the local computer 14 with internet or network 221, FIG. 2 connection to the web server 163 be configured to permit the local computer 14 user to control certain activity and data collection by the mobile device 12 by way of the device-side software 121 remotely, and monitor the RF network data live 190 in real time. The collected RF data 190 on the mobile device 12 with the device-side software 141, may be collected and/or stored as log files 200, which can then be remotely transferred, using the local system 141. All RF tests or measurements may be user-initiated, either in real-time, or through a scheduling 250, FIG. 2 mechanism. The RF test initiation can be done on-site by using the mobile device 12 with device-side software 121, or may be initiated remotely from anywhere in the world by a system engineer at his or her work station (i.e., the local computer 14 with the computer side software 141. As indicated above, all or some of the multiple server 16, 20, 163, 165, 166, 167 components can reside in a single physical server 16. The need for having multiple servers can be eliminated.

In operation, one application of the present invention may be carried out by a field engineer moving (walking or driving) through an area (indoor or outdoor) served by an RF telecommunications service with his or her mobile device 12 loaded with the device-side software 121 running on the mobile device 12. A local system engineer located anywhere in the world using a computer 14 with the computer-side software 141 loaded and an active internet connection 221 can connect to the mobile device 12 remotely and execute various tests remotely to monitor and collect RF network data 190. According to the system engineer's observations of the network data 190 streamed live from the mobile device 12 in real time, recommendations can be made to the field engineer to fix any network issues. This illustrates how the present embodiment which provides real-time access to the chip-set data 190 stream accompanied with remote access control of the device 12 to manipulate the device 12 to perform any function or test.

In at least one example of empirical testing of the invention, the applicant was hired by AT&T® to do a pre-drive analysis and optimization for a golf course prior to a major PGA event. A field engineer with a mobile device loaded with an embodiment of the platform system described herein drove around the golf course while the system engineers in the home office analyzed, in real time, the various RF parameters of the nearby antennas that were serving the golf course. The system engineers were able to remotely start/stop tests on the mobile device from the office as desired to view the telecommunications network being assessed. By viewing the device's received parameters in real time through the local desktops, the system engineers were able to identify problem sectors that were swapped (pointing at the wrong directions). There was no need to email/upload the log data and process it in the office in order to reschedule the tower crew and bring the field engineer back again for a re-drive. The technician, tower crew and the office engineers could communicate and work in conjunction to resolve the issue in real time using an embodiment of the present invention, resulting in significant reduction of time and cost over prior techniques. Therefore, this illustrates how the present embodiment the present embodiment based on live interactions and directed activities and how it can be defined as having “learning” capabilities too.

In one application, embodiments of the present invention may be employed to enhance and expedite radio access network engineering services. Other applications are contemplated, including emergency communications (e.g., 911) for public safety, and device and network performance for understanding the mobile user experience in granular detail. Specifically consider a device 12 that is currently experiencing degraded service. Initially, neither the operator nor the user knows if the defect is related to the network 222 or the device 12. the present embodiment, the bi-directional, live and real-time 170 connection between the device 12 and the remote operator having chip set data stream 190 available has the capability to evaluate both the device 12 and the network 221 in real time and in accompaniment with other devices 12 nearby.

It is contemplated that applications of some embodiments of the present invention may comprise origination and/or termination of calls from the central server 16 in order to run user tests ranging from voice communication capability (including but not limited to retainability and accessibility) to data communication capability (including but not limited to ftp, http, https, ping, smtp/email, video on demand, multi-radio access bearer, etc.). It is contemplated that embodiments of the inventive platform 10 may comprises analytics tool that may be used to report live data with real time data feed from the various software elements. Examples include single site verification, pre-integration call tests, site shakedown tests, throughput tests, verification and validation tests, network benchmark testing, device testing and certification, neighbor verification and change validation, and automated customer troubleshooting.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A platform for facilitating bi-directional, real-time transmission of raw surface level and chipset level data collected by a remote computerized device, where the bi-directional transmission is made between the remote computerized device and a local computerized device comprising:
at least one remote computerized device comprising a wireless communications device with chip sets equipped with at least one modem and I/O port streaming data, and device side software;
a network connecting the wireless communications device;
at least one local computerized device comprising a workstation equipped with software;
a network connecting the workstation;
at least one server equipped with server side software associated with the workstation;
at least one database;
a communications engine installed within the device side software on the remote computerized device and within server side software on the local computerized device;
at least one console; and,
at least one operator

2. The platform in claim 1, which is configured to manage the bi-directional, real-time transmission of the data collected in streaming fashion, where the data collected is obtained from the I/O port or modem and compressed for transmission by the communications engine and transmitted either periodically pursuant to an established frequency of transmission or upon the request of the local computerized device or at the direction of the operator.

3. The communications engine in claim 2, which subjects the complete chip set data stream to be captured, compressed and transmitted to the remote server enabling the remote operator, either human or machine, to process the raw data stream in real time to perform every function capable on the device, in addition to any other function or test which the remote server can be programmed to perform without altering, disabling or modifying the device.

4. The data stream in claim 3, which is compressed in real-time to very low data rates under 1 Kb/s to maintain extremely light payload so as not to overburden the device or the network while transferring the data. Accordingly, the impact on the performance of the device is minimized.

5. The communication engine in claim 1, further comprising a downloadable application corresponding to the remote computerized device, and a downloadable or installable software program also corresponding to the local computerized device, server and database; thereby enabling any commercially available device to be utilized in this solution where the application can be downloaded and installed.

6. The platform in claim 1, which can initiate the enablement of simultaneous bi-directional remote computerized device connections to different remote computerized devices independent of location and proximity of the remote computerized devices; where an additional software enhancement in the communications engine can be deployed on the remote computerized device which then can be slaved off a second remote computerized device resulting in a master-slave configuration of remote computerized devices communicating with the local computerized device.

7. The remote computerized device in claim 1, which is configured to collect and transmit bi-directionally in real-time streaming fashion surface level and chipset level data, including but not limited to data which is reflective of telemetry associated with an ambient RF telecommunications service; collecting telecommunication service telemetry remotely through the exposure of the mobile device with the device-side agent to the telecommunication service telemetry; decoding and transmitting in real-time surface level and chipset level data reflective of telemetry associated with the telecommunications service;

8. The database in claim 1, which is configured to store at least part of the platform software so that functionality of the platform is performed manually and/or automatically, where the main server is configured to be in wired or wireless electronic communication with the local computerized device and the remote computerized device to permit and facilitate transfer of data there between.

9. The platform in claim 1, whereby the operator located at the local computerized device site is permitted to remotely access and direct actions and functions of the remote computerized device.

10. The platform in claim 10, wherein the operator utilizing the remote access permitted assumes autonomous control of the remote computerized device from the console to directly initiate commands and function requests in manual, or automated fashion, to the communications engine for formatting and synchronization with the chip set of the device.

11. The operator in claim 10, which is a human being or a machine which can be programmed to perform various functions, including executing automated scripts and learning adaptations.

12. The operator in claim 11, either human or machine, having bi-directional, real-time access to both chip set steaming data and remote control of the device, can undertake actions in real time.

13. The operator in claim 12, has real-time, live access to 100% of the data available from the chip set regarding the network, the chip set itself, and the functions of the device which the operator can control; and, which data and functions can be displayed on the remote computerized device.

14. A method using bi-directional, real-time transmission of raw surface level and chipset level data collected by a remote computerized device operating under conditions where the local computerized device is only receiving fractional real-time streaming fashion surface level and chipset level data set even if the remote computerized device is only transmitting intermittently, wherein by analysis of the raw compressed hex code data stream received, sufficient information used in analysis will allow the operator to discern and conclude what is happening regarding the performance and functionality of the remote computerized device and what is causing the degraded performance.

15. A method using bi-directional, real-time transmission of raw surface level and chipset level data collected by a remote computerized device for improving and/or restoring any non-functioning or poorly functioning aspects of the telecommunications service, including assessing the absence of service in specific geographic locations wherein the operator located at the local computerized device site remotely accesses and directs actions and functions of the remote computerized device to correct configurations, program or otherwise manipulate settings and parameters on the remote computerized device to restore satisfactory service on the remote computerized device.

16. A method using bi-directional, real-time transmission of raw surface level and chipset level data collected by a remote computerized device in which the remote operator not only can collect and interact with the device, chip set and network under satisfactory operating conditions when no events or incidents are reported; but, this same solution is available when everything else seems to be going wrong.

17. The method of claim 11, wherein the platform is operated by the operator for providing radio access network engineering services; discovery and response to anomalies, abnormalities, or newly discoverable events; and which is capable of processing data in real-time or as post analysis after-action review.

18. A method using bi-directional, real-time transmission of raw surface level and chipset level data collected by many distinct remote computerized devices to collect data used to quantify and characterize the current conditions in a local area of a broader network as baseline to which subsequent data sets can be compared.

19. A method for utilizing a communications engine as chip level interface to the modem and I/O ports of the device to intercept the complete, unfiltered, and unaltered raw hex, binary coding or other machine language formatted data streams from these core components of the device, which compresses and transmits the data in real time to a local computerized device, server and database.

20. A method for utilizing a downloaded communications engine as chip level interface to the modem and I/O ports of the device to intercept the complete, unfiltered, and unaltered raw hex coding data streams from these core components of the device, which compresses and transmits the data in real time to a local computerized device, server and database; wherein no permanent modification or functional impairment occurs to the device on which the communications engine is install and which communication engine can be removed without any residual trace on the device.
